(19) United States
(12) Patent Application Publication
(10) Pub. No.: US 2024/0221016 A1
(43) Pub. Date: Jul. 4, 2024

(54) SYSTEM FOR PROVIDING REWARD SERVICE USING INSERTION-TYPE REWARD MODULE, AND METHOD THEREOF

(71) Applicant: AVATYE CO., LTD., Gyeonggi-do (KR)

(72) Inventors: Geum Uk SEO, Gyeonggi-do (KR); Won Hyuck CHOI, Gyeonggi-do (KR)

(73) Assignee: AVATYE CO., LTD., Gyeonggi-do (KR)

(21) Appl. No.: 17/767,512

(22) PCT Filed: Sep. 2, 2020
(86) PCT No.: PCT/KR2020/011752

§ 371 Date: Jan. 5, 2024

(30) Foreign Application Priority Data
Oct. 11, 2019 (KR) 10-2019-0125851

(51) Int. Cl. G06Q 30/0207

(52) U.S. Cl. CPC G06Q 30/0207

(57) ABSTRACT

Provided are a system for providing a reward service using an insertion-type reward module, and a method thereof. A system for providing a reward service according to some embodiments of the present disclosure may comprise: a reward module which is inserted into an app, displays a predetermined indicator while the app is running, displays advertisement content in response to an input of a user associated with the displayed indicator, and transmits a request for accumulating rewards calculated according to predetermined conditions to a reward service providing server; and the reward service providing server which accumulates the calculated rewards corresponding to the user in response to the accumulation request.

### TECHNICAL FIELD

The present disclosure relates to a system and method for providing a reward service using an insertion-type reward module. More particularly, the present disclosure relates to a system, which is capable of providing a reward service to a user of a non-reward app using a reward module inserted into the non-reward app, and a method performed in the system.

### BACKGROUND ART

With the expansion of the spread of mobile terminals, the mobile advertising market continues to grow at a higher growth rate every year. Recently, reward advertising in which a reward is paid to a user who has watched an advertisement has received attention from users and, in particular, mobile apps (i.e., reward apps) are being actively used as advertising media.

However, despite the fact that reward advertisements are attractive advertisement products from the point of view of media operators and advertisers, the reward advertising market is still small when compared to the simple exposure type advertising market such as bottom banners (i.e., non-reward advertisements). This is because reward apps generally have high technical difficulty (e.g., it is difficult to determine whether the user has met reward conditions through normal methods), require much development cost, and also require high operating cost due to the handling of inquiries regarding reward non-payment and the like. Further, as advertiser's reward conditions become more complex and difficult day by day, much marketing cost is incurred to acquire and maintain users of a reward app (e.g., marketing cost is constantly required due to frequent user churn). This is because the profits of the reward app operators are ultimately worsened.

Meanwhile, many apps that do not have their own paid monetization model are generating profits through strip banners or pop-up banners. However, by exposing users to advertisements without regard for the users' intentions, banners cause inconvenience and fatigue to app users and are becoming a key factor in causing the users to leave apps.

Therefore, there is a need for a method of providing reward advertising in a way that does not cause inconvenience to app users and does not cause any objection, and at the same time, expands reward advertising participants to all users of mobile apps.

### SUMMARY

### Technical Problem

The present disclosure is directed to providing a system, which is capable of providing a reward service using an insertion-type reward module, and a method performed in the system.

The present disclosure is also directed to providing a system, which is capable of providing a reward service in a way that does not cause inconvenience and fatigue to an app user, and a method performed in the system.

Objects according to the technical spirit of the present disclosure are not limited to the above-described objects and other objects that are not described may be clearly understood by those skilled in the art from the following descriptions.

### Technical Solution

One aspect of the present disclosure provides a system for providing a reward service using an insertion-type reward module, the system including a reward module which is inserted into an app, displays a predetermined indicator while the app is running, displays advertisement content in response to an input of a user associated with the displayed indicator, and transmits a request for accumulation of rewards calculated according to predetermined conditions to a reward service providing server, and the reward service providing server configured to accumulate the calculated rewards corresponding to the user in response to the request for accumulation.

In some embodiments, the reward module may probabilistically determine whether to display the advertisement content in response to the input of the user.

In some embodiments, the reward module may probabilistically determine whether to display the predetermined indicator.

In some embodiments, the reward module may calculate an earnable reward and display the calculated earnable reward together inside of the indicator or adjacent to the indicator.

In some embodiments, the reward module may calculate an earnable reward and determine a visual element of the indicator on the basis of the calculated earnable reward.

In some embodiments, the reward module may display the indicator on an execution screen of the app in a floating manner.

In some embodiments, the reward module may calculate an earnable reward and provide the calculated earnable reward in the form of a push notification in response to determining that the app is running in the background.

In some embodiments, the reward module may generate an identification value associated with the app, and the reward service providing server may accumulate the calculated rewards corresponding to the generated identification value before an account of the user is generated and transfer the accumulated rewards to the account of the user in response to the generation of the account of the user.

Another aspect of the present disclosure provides a method of providing a reward service using an insertion-type reward module, which is a method of providing a reward service using a reward module inserted into an app in a terminal of a user, the method including outputting an indicator displaying an earnable reward while the app is running through a display of the terminal, detecting an input of the user associated with the displayed indicator, displaying advertisement content through the display in response to the detected input of the user, and accumulating rewards calculated based on the earnable reward corresponding to the user.

Still another aspect of the present disclosure provides a user terminal including a display, a memory configured to store an app into which a reward module is inserted, a communication unit configured to communicate with a reward service providing server, and a processor configured to control the display, the memory, and the communication unit, wherein the processor is set to output an indicator displaying an earnable reward while the app is running through the display, detect an input of the user associated with the output indicator, display advertisement content through the display in response to the detected input of the user, and transmit the calculated rewards to the reward service providing server through the communication unit so that the calculated rewards are accumulated based on the earnable reward to correspond to the user.

### Advantageous Effects

According to various embodiments of the present disclosure described above, various positive effects can be generated and the reward service market can be activated, and the effects are summarized below from the point of view of advertisers, app operators, and users.

First, from the point of view of the advertiser, in the past, advertising was only possible through a dedicated app developed for a reward service, and thus the target audience itself had to be limited to specific users and specific categories of apps. This acted as a key limitation limiting the growth of the reward advertising market in that it was difficult for more advertisers to provide advertisements to a wide range of users. However, according to various embodiments of the present disclosure described above, a reward function can be inserted in various non-reward apps in the form of a module, and thus reward advertising participants can be expanded to all users of the mobile app. Accordingly, a wide advertising target audience can be provided to the advertiser who wants to execute reward advertising products.

Next, from the point of view of the app operator, in the case of existing apps (i.e., non-reward apps), monetization was possible only through banners and the like, and thus excessive banner exposure frequently caused inconvenience and fatigue to app users. However, according to various embodiments of the present disclosure, by inserting a simple reward module, users of the app can naturally use the reward service, allowing the app operator to earn additional revenue. Furthermore, the reward function is mounted within a range that does not harm the usability of the app, and thus the user churn problem can be alleviated. Accordingly, the app operator can earn additional revenue more stably.

Next, from the point of view of the user, there is no need to separately install a reward app to obtain rewards and users can receive the rewards naturally from the apps that the users have been using for other purposes, and thus user convenience can be significantly improved. Furthermore, the reward function can be used within a range that does not harm concentration on the app, and thus the problem of inconvenience to the user due to excessive banners can be solved.

Effects obtainable in the present disclosure are not limited to the above-described effects and other effects that are not described may be clearly understood by those skilled in the art from the following descriptions.

### BRIEF DESCRIPTION OF THE DRAWINGS

FIG. 1 is an exemplary configuration diagram illustrating a system for providing a reward service using an insertion-type reward module according to some embodiments of the present disclosure.

FIG. 2 is an exemplary diagram illustrating correspondence between an insertion-type reward module and apps according to some embodiments of the present disclosure.

FIG. 3 is an exemplary block diagram illustrating a reward service providing server according to some embodiments of the present disclosure.

FIG. 4 is an exemplary flowchart illustrating a method of providing a reward service using an insertion-type reward module according to some embodiments of the present disclosure.

FIG. 5, FIG. 6 and FIG. 7 are exemplary diagrams for describing user interfaces (UIs) related to an indicator according to some embodiments of the present disclosure.

FIG. 8 is an exemplary diagram for describing a UI for providing advertisement content according to some embodiments of the present disclosure.

FIG. 9, FIG. 10 and FIG. 11 are exemplary diagrams for describing a UI related to a widget or a push notification according to some embodiments of the present disclosure.

FIG. 12 is an exemplary diagram for describing a reward accumulation method according to some embodiments of the present disclosure.

FIG. 13 and FIG. 14 are exemplary diagrams for describing methods of providing a blockchain-based reward service according to some embodiments of the present disclosure.

FIG. 15 illustrates an example of a computing device that may be used for implementing devices according to various embodiments of the present disclosure.

### DETAILED DESCRIPTION

Hereinafter, exemplary embodiments of the present disclosure will be described in detail with reference to the accompanying drawings. Advantages and features of the present disclosure and methods of achieving the same will be clearly understood with reference to the accompanying drawings and embodiments described in detail below. However, the technical scope of the present disclosure is not limited to the embodiments to be disclosed below but may be implemented in various different forms. The following embodiments are provided in order to fully explain the present embodiments and fully explain the scope of the present disclosure for those skilled in the art. The scope of the present disclosure is only defined by the appended claims.

In this specification, when reference numerals are assigned to components of each drawing, it should be noted that, when the same components are illustrated in different drawings, the same numerals are assigned to the same components whenever possible. Further, in descriptions of the present disclosure, when detailed descriptions of related well-known technology are deemed to unnecessarily obscure the gist of the present disclosure, the detailed descriptions will be omitted.

Unless otherwise defined, all terms (including technical and scientific terms) used herein can be used as is customary in the art to which the present disclosure belongs. Also, it will be further understood that terms, such as those defined in commonly used dictionaries, will not be interpreted in an idealized or overly formal sense unless expressly so defined herein. The terms used herein are provided only to describe embodiments of the present disclosure and not for purposes of limitation. In this specification, unless the context clearly indicates otherwise, the singular forms include the plural forms.

Further, in describing elements of the present disclosure, terminologies such as “first,” “second,” “A,” “B,” “(a),” and “(b)’ may be used. The terms are used to distinguish an element from another element, but the nature, order, or sequence of the elements is not limited by the terminology. It will be understood that when an element is referred to as being “connected” or “coupled” to another element, the element can be directly connected or coupled to another element, or the element can be connected or coupled to another element with still another element disposed therebetween.

It will be understood that the terms “comprise” and/or “comprising,” when used herein, specify some stated components, steps, operations and/or elements, but do not preclude the presence or addition of one or more other components, steps, operations and/or elements.

Prior to the description of the present disclosure, some terms used in this specification will be clarified.

In this specification, a non-reward app may be an app other than a dedicated app (e.g., an app whose main purpose is to pay points in return for watching advertisements so that a product can be purchased with the accumulated points or the accumulated points can be exchanged for cash) developed for a reward service. That is, the non-reward app may be any app whose main purpose is not to provide a reward service, such as a game app or the like.

In this specification, an insertion-type reward module is a software module in which a function (e.g., advertisement content display, reward provision, etc.) for a reward service is implemented, and may be a module which is inserted to add a reward function to a non-reward app. Here, a case in which a reward module is inserted into an app may include a case in which the reward module communicates with the app in addition to a case in which the reward module forms a part of the app.

In this specification, an instruction is a series of computer readable instructions grouped according to a function, and is a component of a computer program and refers to being executed by a processor.

Hereinafter, various embodiments of the present disclosure will be described in detail with reference to the accompanying drawings.

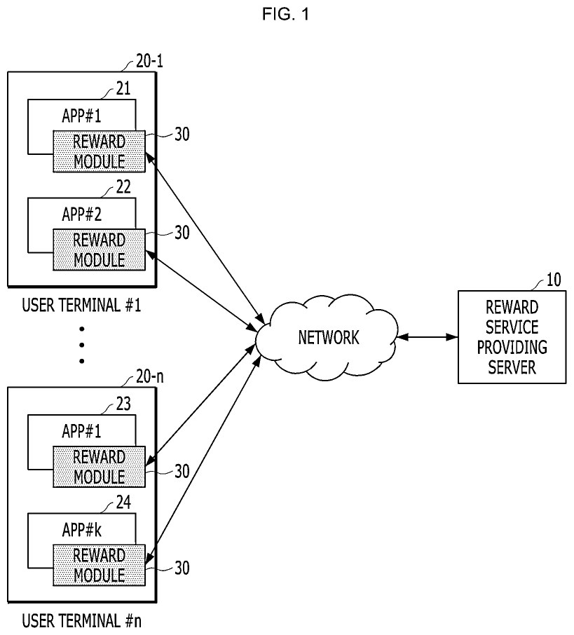

FIG. 1 is an exemplary configuration diagram illustrating a system for providing a reward service using an insertion-type reward module according to some embodiments of the present disclosure.

As illustrated in FIG. 1, the system for providing the reward service may include a reward service providing server 10, and reward modules 30 each mounted on one of user terminals 20-1 to 20-n. It should be understood, however, that this is only an exemplary embodiment for achieving the objects of the present disclosure, and that some components may be added or deleted as necessary. Further, it should be noted that the respective components of the system for providing the reward service illustrated in FIG. 1 are illustrated as functional elements which are functionally distinguished, and that a plurality of components may be implemented to be integrated with each other in an actual physical environment.

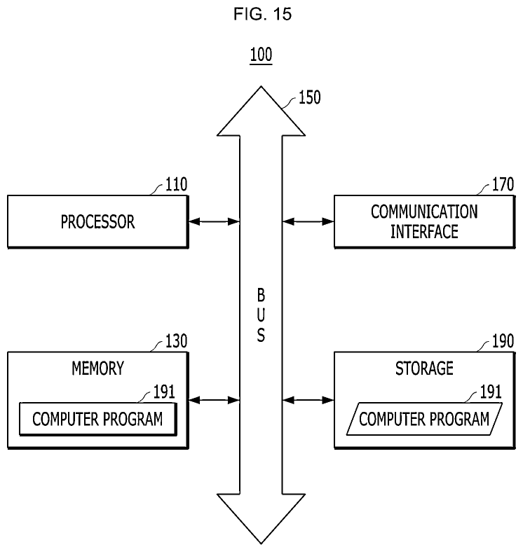

Further, in the actual physical environment, the respective components may be implemented to be divided into a plurality of detailed functional elements. For example, the reward service providing server 10 may be implemented in a plurality of computing devices. For example, a first function of the reward service providing server 10 may be implemented in a first computing device, and a second function may be implemented in a second computing device. Further, the first function and the second function of the reward service providing server 10 may be divided and implemented in a plurality of computing devices. An example of such a computing device will be described with reference to FIG. 15. Hereinafter, each component of the system for providing the reward service will be described.

In the system for providing the reward service, the reward service providing server 10 is a computing device that provides a reward service to a user in conjunction with the reward module 30. Here, the computing device may include any type of device having a computing function and a communication function, such as a notebook computer, a desktop computer, a laptop computer, or the like. However, in an environment in which a reward service is provided to a plurality of users, the reward service providing server 10 may be implemented as a high-performance server-grade computing device.

Specifically, the reward service providing server 10 may provide a reward service to users of non-reward apps (e.g., 21 to 24) installed in the user terminals 20-1 to 20-n through the reward modules 30. For example, the reward service providing server 10 may expose a user to advertisement content through the reward module 30, and accumulate a reward according to the exposure to correspond to the user. The detailed configuration and operation of the reward service providing server 10 will be described below in more detail with reference to FIG. 3. In the following description, for convenience of description, the reward service providing server 10 is abbreviated as “reward server 10,” and “app” is used to refer to a “non-reward app” unless otherwise stated. Further, the reference numeral “20” is used to refer to any of the user terminals 20-1 to 20-n or to collectively refer to the user terminals 20-1 to 20-n.

In the system for providing the reward service, the reward modules 30 are modules that are mounted on the user terminals 20 and provide the reward service to the users of the non-reward apps (e.g., 21 to 24) in conjunction with the reward server 10. For example, the reward module 30 may display advertisement content on the user terminal 20 in response to a user input, calculate a reward to be paid to the user, and transmit a request for accumulation of the calculated reward to the reward server 10. Then, the reward server 10 may accumulate the reward corresponding to the user.

The reward may include any type of value, such as points, discount coupons, gift cards, mileage, cryptocurrency, etc. Further, the reward may include both of an accumulated reward and a non-accumulated reward. As described above, since the form and type of the reward may vary according to embodiments, the technical scope of the present disclosure is not limited by the form and type of the reward.

A detailed function of the reward module 30 and a process of providing a reward service through the reward module 30 will be described in detail with reference to the drawings after FIG. 3.

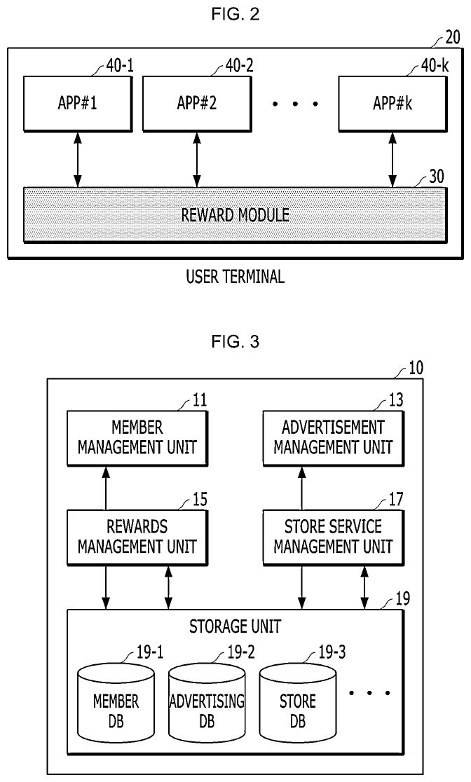

Meanwhile, FIG. 1 illustrates an example in which the reward module 30 is inserted into each of the apps (e.g., 21, 22, 23, and 24). However, in another embodiment of the present disclosure, the reward module 30 may provide a reward service in conjunction with a plurality of apps (e.g., 21, 22, 23, and 24). For example, as illustrated in FIG. 2, the reward module 30 may be implemented in the form of a module (e.g., a daemon) that communicates with each of a plurality of apps 40-1 to 40-k and is running in the background.

A user terminal 20 is a terminal and computing device possessed by a user of an app and may be implemented as a handheld device such as a smartphone, a wearable device, or the like. However, the present disclosure is not limited thereto, and the user terminal 20 may be implemented as one of various types of computing devices. An example of the computing device will be described with reference to FIG. 15.

In various embodiments of the present disclosure, the reward module 30 (or user terminal 20) and the reward server 10 may communicate with each other through a network. Here, the network may be implemented as any type of wired/wireless network such as a local area network (LAN), a wide area network (WAN), a mobile radio communication network, wireless broadband (WiBro) Internet, or the like.

The system for providing the reward service using the insertion-type reward module according to some embodiments of the present disclosure has been described above with reference to FIGS. 1 and 2. Hereinafter, the configuration and operation of the reward server 10 will be described with reference to FIG. 3.

FIG. 3 is an exemplary block diagram illustrating the reward server 10 according to some embodiments of the present disclosure.

As illustrated in FIG. 3, the reward server 10 may include a member management unit 11, an advertisement management unit 13, a rewards management unit 15, a store service management unit 17, and a storage unit 19. However, in FIG. 3, only components related to the embodiment of the present disclosure are illustrated. Therefore, it can be seen by those skilled in the art to which the present disclosure pertains that the present disclosure may further include general-purpose components in addition to the components illustrated in FIG. 3. Further, the respective components 11 to 17 of the reward server 10 illustrated in FIG. 3 represent functional elements that are functionally distinguished, and a plurality of components may be implemented to be integrated with each other in an actual physical environment, or a single component may be implemented to be divided into a plurality of detailed components. Further, in other embodiments of the present disclosure, some of the components 11 to 17 illustrated in FIG. 3 may be omitted. Hereinafter, each component will be described.

The member management unit 11 may be in charge of all functions related to members of the reward service. For example, the member management unit 11 may perform membership registration processing (e.g., user account generation or the like), membership withdrawal processing, login/logoff processing, and the like. Further, the member management unit 11 may manage member information in conjunction with the storage unit 19.

Next, the advertisement management unit 13 may be in charge of all functions related to advertisement content. For example, the advertisement management unit 13 may transmit advertisement content to the reward module 30 or perform scheduling for a plurality of pieces of advertisement content. Further, the advertisement management unit 13 may store or view the advertisement content in conjunction with the storage unit 19.

In some embodiments, the advertisement management unit 13 may classify various pieces of advertisement content provided by advertisers or advertisement providers without repetition, and may provide a list of the classified advertisement content to the user. More specifically, since data formats or identification values of the advertisement content may vary for each advertisement provider, repeated advertisement content may be provided to the users as different rewards. In order to prevent the above problem, the advertisement management unit 13 may classify the advertisement content on the basis of title similarity of the advertisement content, a market type (e.g., Google Play, App Store, or One Store) of the app where the advertisement content is found, and the like. Further, the advertisement management unit 13 may transmit the list of the classified advertisement content to the user terminal 20 through the reward module 30. In this case, the advertisement management unit 13 or the reward module 30 may sort a plurality of pieces of advertisement content classified as the same advertisement (or a plurality of pieces of advertisement content classified as different advertisements) on the basis of a size of the reward (e.g., an amount of the reward), and may sequentially expose the user to the advertisement content starting with advertisement content having a high reward. By doing this, the user may be exposed to the advertisement content having the high reward first, and as a result, the user's profitability can be improved, and the advertisement exposure effect can be improved according to the amount of the reward paid by the advertiser.

Further, the advertisement management unit 13 or the reward module 30 may provide the list of the advertisement content in response to a request received from the user terminal 20. For example, in response to the request received from the user terminal 20 which is intended to receive an additional reward, the advertisement management unit 13 or the reward module 30 may transmit the list to the user terminal 20. Further, the user may select and watch advertisement content included in the list and receive an additional reward.

Next, the rewards management unit 15 may be in charge of all functions related to the reward. For example, the rewards management unit 15 may accumulate (e.g., accumulate in the user's member account) the reward to correspond to the user according to a request for accumulation received from the reward module 30. Further, the rewards management unit 15 may store or view a reward accumulation history in conjunction with the storage unit 19.

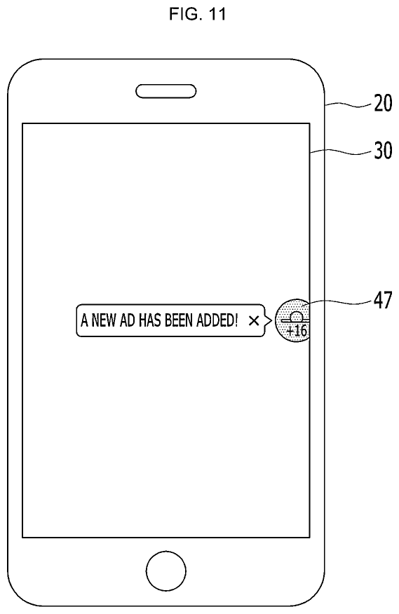

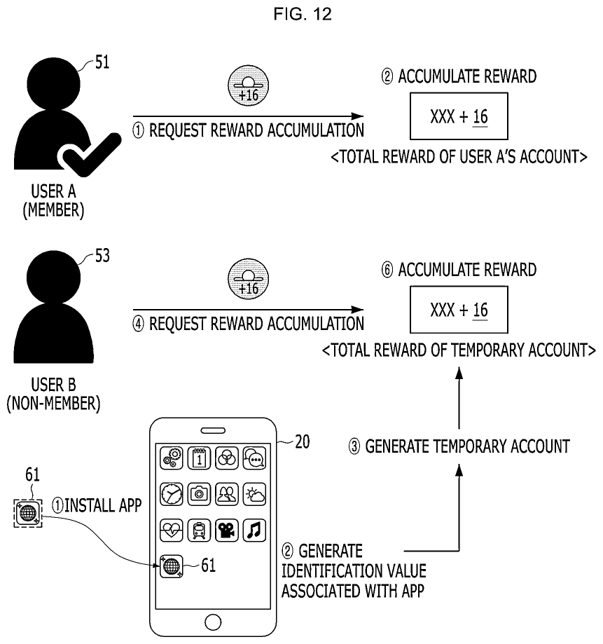

In some embodiments, when the user who requested the accumulation is a non-member, the rewards management unit 15 may accumulate the reward in a temporary account. That is, instead of forcing membership registration, the rewards may be accumulated in the temporary account first, and then membership registration may be encouraged later. According to the present embodiment, it is possible to accumulate rewards without going through a cumbersome membership registration process, thereby increasing user convenience and improving accessibility of the reward service. The present embodiment will be described below in more detail with reference to FIG. 12.

Further, in some embodiments, the rewards management unit 15 may manage coupons, gift cards, etc. for products that can be purchased in various stores, and may pay the coupons, the gift cards, etc. as a reward to the user.

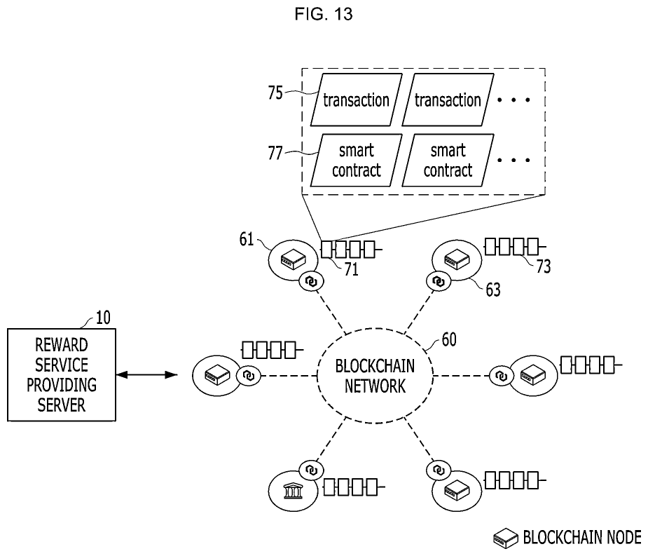

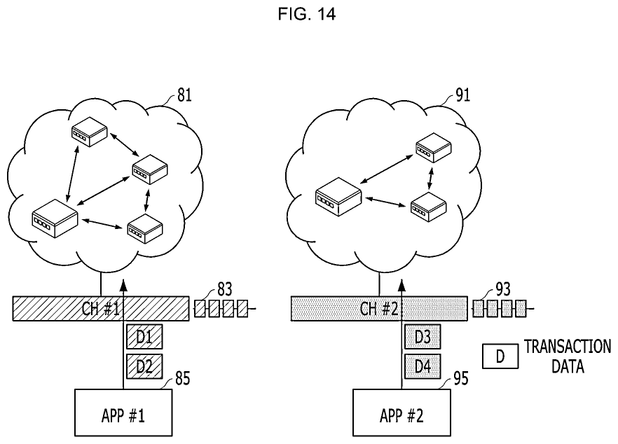

Further, in some embodiments of the present disclosure, the reward server 10 may provide a reward service in conjunction with a blockchain network. In the present embodiment, the rewards management unit 15 may pay cryptocurrency issued through the blockchain network as a reward and record a reward payment history in a blockchain shared in the blockchain network. The present embodiment will be additionally described below with reference to FIGS. 13 and 14.

Next, the store service management unit 17 may be in charge of all functions related to a store service. Here, the store service may include any service provided so that the user can use the accumulated rewards (e.g., product purchase, currency exchange, etc.). The store service management unit 15 may store or view a reward usage history in conjunction with the storage unit 19.

Next, the storage unit 19 may store and manage various pieces of information related to the reward service through database (DB) storage media (e.g., 19-1 to 19-3). The information may include, for example, member information, advertisement content-related information, a reward accumulation history, a reward usage history, etc.

Each of the components (e.g., 11 to 19) of FIG. 3 may refer to software or hardware such as a field programmable gate array (FPGA) or an application-specific integrated circuit (ASIC). However, the components are not limited to software or hardware and may be configured to be included in an addressable storage medium or configured to execute one or more processors. The functions provided in the components may be implemented by more subdivided components or may be implemented as one component that performs a specific function by combining a plurality of components.

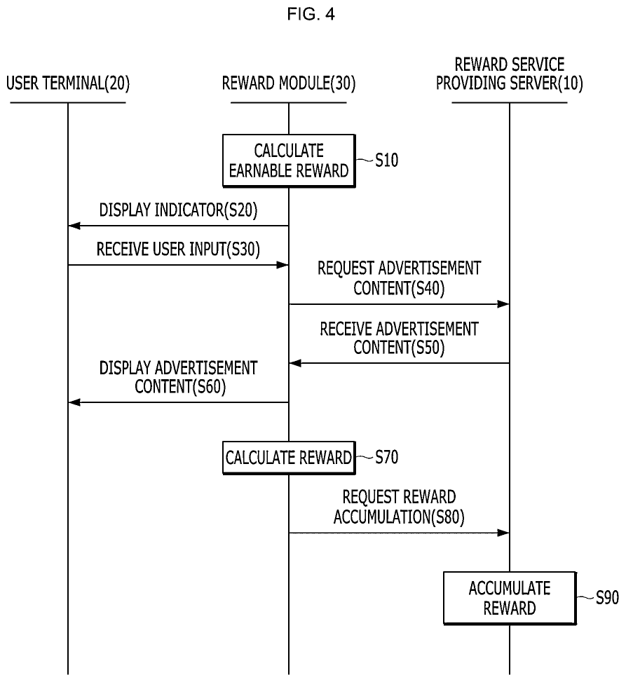

Hereinafter, a method of providing a reward service using an insertion-type reward module according to some embodiments of the present disclosure will be described with reference to the drawings after FIG. 4. For convenience of description, description will be made assuming a case in which the method is performed in the system illustrated in FIG. 1. Further, hereinafter, for convenience of description, description will be made assuming a case in which the reward is points. However, it should be clearly understood by those skilled in the art that even when the reward is of a different type, the method to be described below may be applied without changing the actual technical idea.

FIG. 4 is an exemplary flowchart illustrating a method of providing a reward service using an insertion-type reward module according to some embodiments of the present disclosure. It should be understood, however, that this is only an exemplary embodiment for achieving the objects of the present disclosure, and that some operations may be added or deleted as necessary.

As illustrated in FIG. 4, the method of providing the reward service may start in operation S10 of calculating, by the reward module 30, an earnable reward. Here, the earnable reward may be a reward currently payable to the user. A specific method of calculating the earnable reward may vary according to embodiments.

In some embodiments, the earnable reward may be calculated in an increasing manner over time. For example, the earnable reward may gradually increase over time within a certain limit. The earnable reward may increase periodically and constantly or may increase non-periodically. In this case, a degree to which the earnable reward increases may be set in various ways. For example, when an app into which the reward module 30 is inserted is running in the foreground (e.g., when an execution screen of the app is displayed on a display of the terminal 20), the earnable reward may increase relatively rapidly. On the other hand, when a non-reward app into which the reward module 30 is inserted is running in the background, the earnable reward may not increase or may increase relatively slowly. By doing this, the user may be encouraged to further use the app into which the reward module 30 is inserted, and the app operator may be ultimately encouraged to more actively introduce the reward module 30.

In some embodiments, the earnable reward may be calculated in an increasing or decreasing manner in response to occurrence of a specific event. The event may be, for example, any of different types of actions that indicate a user's intention to watch an advertisement (i.e., an intent to earn a reward), such as an action of running or using a reward app, an action of watching advertisement content through another non-reward app, an action of watching an indicator displaying an earnable reward, and the like. Further, the event may include an action regarded as cherry picking, such as an action of forcibly ending advertisement content during watching. According to the present embodiment, the earnable reward may increase or decrease in consideration of the user's intention, and thus the use of the reward service may be more actively encouraged.

In some embodiments, the earnable reward may be calculated based on a combination of the above-described embodiments. For example, the earnable reward may increase over time and may be adjusted according to occurrence of a specific event.

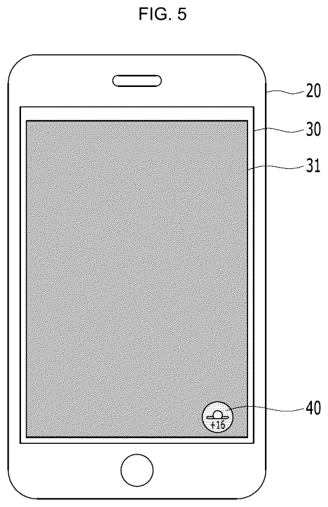

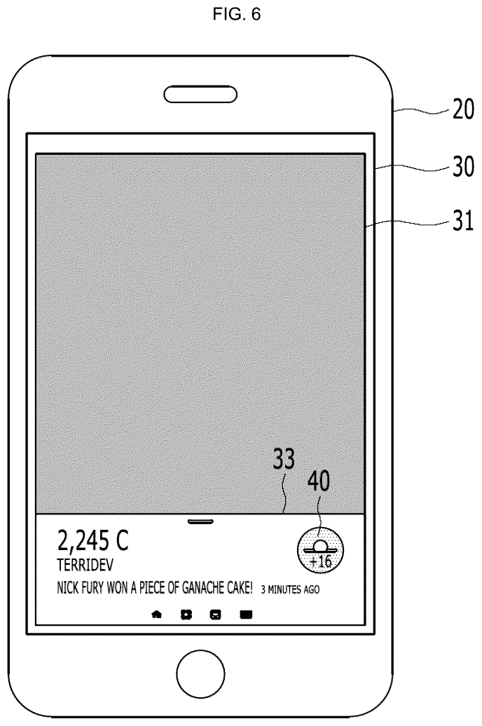

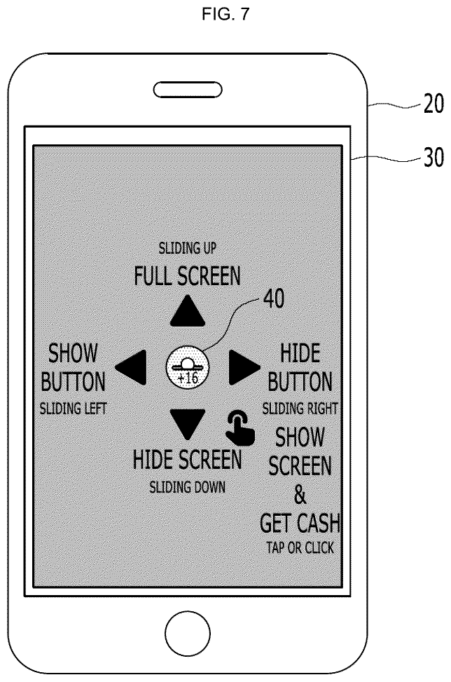

In operation S20, the reward module 30 may display a predetermined indicator on the display of the user terminal 20. In this case, in order to encourage the user's participation, the previously calculated earnable reward may be displayed together inside of the indicator or adjacent to the indicator. For example, as illustrated in FIG. 5, an indicator 40 that displays an earnable reward (e.g., 16 points) therein may be displayed in a floating manner on an app execution screen 31 of a display 30. The reason why the indicator 40 is displayed in the floating manner may be understood to be to minimize user inconvenience without harming the existing usability of the app. Whenever a value of the earnable reward changes, the reward displayed in the indicator 40 may also change in real time.

In some embodiments, a visual element of the indicator 40 may be determined or changed based on the earnable reward. The visual element may include, for example, a size, color, shape, transparency, etc. of the indicator 40, but the present disclosure is not limited thereto, and the visual element may further include other elements. As an example, as the earnable reward increases, the transparency of the indicator 40 may decrease. As another example, when the earnable reward is greater than or equal to a reference value, a highlight effect may be added to the indicator 40. For example, the highlight effect may be set in various ways, such as changing the color of the indicator 40 or the earnable reward to a highlight color, blinking the indicator, changing the size of the indicator, and the like. As still another example, as the earnable reward increases, the size of the indicator 40 may increase. As described above, as the earnable reward increases, the visual element of the indicator 40 may be changed to attract the user's attention, and accordingly, the user's participation may be encouraged and the reward service may be more activated.

In some embodiments, a position of the indicator 40 may be changed based on the earnable reward. For example, as the earnable reward increases, the indicator 40 may be moved to the center of the display to attract the user's attention or may be moved to a position where the user's gaze is located.

In some embodiments, the visual element or position of the indicator 40 may be determined or changed based on the user's concentration on the app. For example, as the concentration on the app increases, the size of the indicator 40 may decrease, the transparency of the indicator 40 may increase, or the position of the indicator 40 may be moved to a periphery of the display. On the other hand, as the concentration on the app decreases, the size of the indicator 40 may increase, the transparency of the indicator 40 may decrease, or the position of the indicator 40 may be moved to the center of the display. The concentration on the app may be calculated in various ways. For example, the reward module 30 may calculate the concentration on the app on the basis of the number of user inputs associated with the app, a user's gaze direction, a user's gaze maintenance time, and the like. According to the present embodiment, it is possible to effectively encourage the use of the reward service without harming the existing usability of the app.

Further, in some embodiments, the earnable reward may be calculated based on the above-described concentration on the app. For example, when the concentration on the app is greater than or equal to a reference value, the earnable reward may be increased relatively slowly, and when the concentration on the app is smaller than the reference value, the earnable reward may be increased relatively rapidly. This can be understood as taking advantage of the fact that the user is more likely to use the reward service while not concentrating on the app.

Meanwhile, in some embodiments, whether the indicator 40 is to be displayed may be determined probabilistically. That is, the indicator 40 is not always displayed, and in some cases, the indicator 40 may not be displayed. This can be understood as serving to minimize the reward function from harming the existing usability of the app.

For reference, in the drawings after FIG. 5, the indicator 40 is illustrated as being implemented in the form of a circular button, but the technical scope of the present disclosure is not limited thereto, and the indicator 40 may be designed and displayed in various forms.

The description will be continued with reference to FIG. 4 again.

In operation S30, the reward module 30 may detect a user input associated with the indicator. For example, in order to obtain a reward, the user may perform an input such as touching the indicator or touching a region adjacent to the indicator, or the like, and the reward module 30 may detect the input.

A specific operation of the reward module 30 according to the detected user input may be variously designed and selected according to embodiments.

In some embodiments, as illustrated in FIG. 6, in response to a user input (e.g., a tap, a double tap, etc.), the reward module 30 may display a main user interface (UI) 33 for a reward function. The main UI 33 may be displayed overlaid on the app execution screen 31, but the technical scope of the present disclosure is not limited thereto. On the main UI 33, a total reward (e.g., 2,245 points) accumulated so far, recently played advertisement content information, advertisement content information to be played next, and the like may be displayed.

In some embodiments, as illustrated in FIG. 7, the reward module 30 may display a UI related to the setting of the indicator 40 in response to a user input. The UI related to the setting of the indicator 40 may display the user input and a function corresponding thereto. Examples of the settable function may include hiding the indicator, displaying the indicator, and the like.

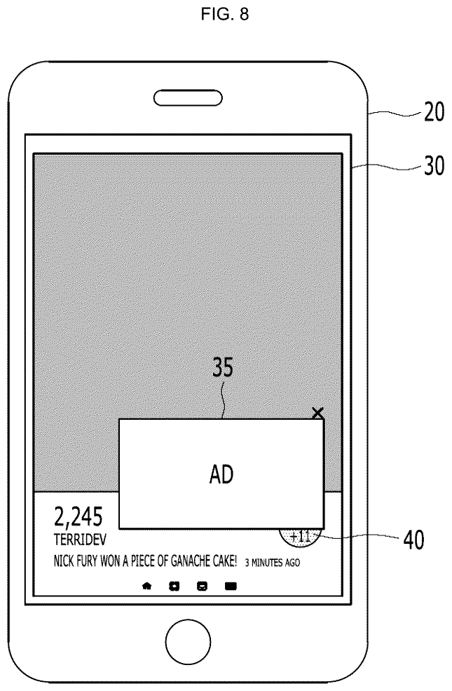

In some embodiments, as illustrated in FIG. 8, the reward module 30 may display advertisement content 35 in response to a user input. A description thereof will be given with reference to the flowchart of FIG. 4 again.

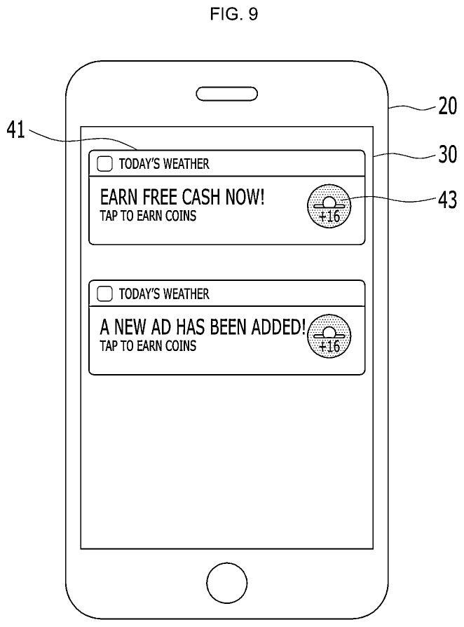

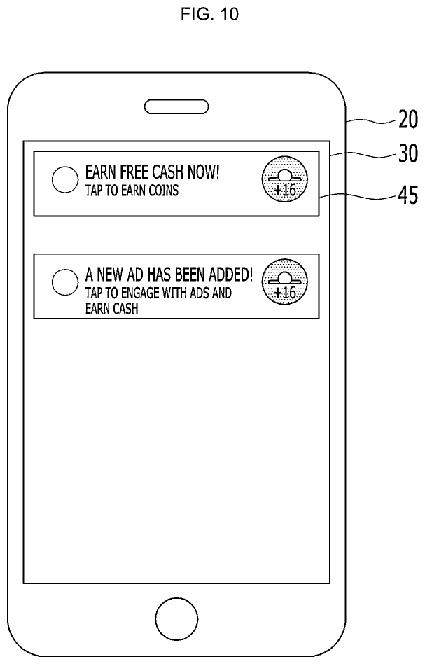

Meanwhile, the reward module 30 has been mainly described above as providing the reward-related function through the UI in the app. However, according to another embodiment of the present disclosure, the reward-related function may be provided through various interfaces outside the app. Hereinafter, the present embodiment will be described with reference to FIGS. 9 to 11.

In some embodiments, as illustrated in FIG. 9, the reward module 30 may display a UI 41 in the form of a widget or a push notification on the display 30 of the user terminal 20. The UI 41 may include an indicator 43 that displays an earnable reward and may include only the earnable reward. Further, various reward notifications such as addition of new advertisement content, payment of an additional reward, and the like may be provided through the UI 41.

The push notification UI 41 may be implemented in another way. For example, as illustrated in FIGS. 10 and 11, a push notification UI 45 may be implemented as a status bar button, or a push notification UI 47 may be implemented as an overlay button.

Further, in some embodiments, when the app is running in the background, a push notification UI for the earnable reward may be displayed. This is because it is necessary to encourage user participation even when the app is not running in the foreground.

The description will be continued with reference to FIG. 4 again.

In operations S40 and S50, the reward module 30 may receive the advertisement content from the reward server 10.

In other embodiments, operations S40 and S50 may be performed prior to operation S30. As an example, the reward module 30 may receive and store the advertisement content in advance, and display the pre-stored advertisement content in response to detecting the user input. As another example, the reward module 30 may receive and store a plurality of pieces of advertisement content in advance, and receive information (e.g., scheduling information such as a type of advertisement content, a display time, etc.) about advertisement content to be displayed from the reward server 10 in response to detecting the user input.

In operation S60, the reward module 30 may display the advertisement content through the display of the user terminal 20. For example, as illustrated in FIG. 8, the advertisement content 35 may be displayed on the display 30 of the user terminal 20. In this operation, a specific method of displaying the advertisement content may vary according to embodiments.

In some embodiments, the advertisement content may be displayed for a time that is proportional to the size of the earnable reward. For example, a minimum playing time of the advertisement content that is not allowed to be skipped may be determined based on the size of the earnable reward.

In other embodiments, the type of content displayed may vary based on the earnable reward. For example, when the earnable reward is smaller than a reference value, simple exposure type advertisement content that does not require the user's participation may be displayed, and when the earnable reward is greater than or equal to the reference value, advertisement content that requires the user's participation may be displayed.

In other embodiments, whenever the user input is received through the indicator, the earnable reward may be deducted and the advertisement content may be displayed. Further, only the deducted amount of rewards may be accumulated to correspond to the user.

Meanwhile, in some embodiments, whether the advertisement content is to be displayed may be determined probabilistically. That is, in some cases, the advertisement content may not be displayed. By doing this, harming of the existing usability of the app may be minimized and the user's participation may be further activated.

In operation S70, the reward module 30 may calculate a reward to be actually accumulated for the user. In this operation, a specific method of accumulating an actual accumulated reward may vary according to embodiments.

In some embodiments, the earnable reward displayed on the indicator may be calculated as an actual accumulated reward.

In some embodiments, an additional reward may be further added to the earnable reward to calculate an actual accumulated reward. The additional reward may be calculated in consideration of the extent to which the user is exposed to the advertisement content. For example, as a total playing time of the advertisement content or a time that the user watches the advertisement content increases, a higher additional reward may be calculated. The time that the user watches the advertisement content may be calculated by collecting images through a camera of the user terminal 20 and tracking the user's gaze through image analysis.

In operations S80 and S90, the reward module 30 may transmit information on the reward calculated in operation S70 to the reward server 10 to request accumulation of the reward. Further, the reward server 10 may accumulate the reward to correspond to the user according to the received information on the reward. Hereinafter, the present embodiment will be additionally described with reference to FIG. 12.

As illustrated in FIG. 12, when a user 51 is a member of the reward service, the reward server 10 may accumulate a reward corresponding to the user's member account (\textcircled{1} and \textcircled{2}).

When a user 53 is a non-member (i.e., before a user account is generated), the reward server 10 may accumulate a reward in a temporary account. Specifically, when an app 61 into which the reward module 30 is inserted is installed in the user terminal 20, the reward module 30 may generate an identification value associated with the app 61 and transmit the identification value to the reward server 10, and the reward server 10 may generate a temporary account using the received identification value (\textcircled{1}, \textcircled{2}, and \textcircled{3}). Then, the reward server 10 may accumulate a reward corresponding to the generated temporary account (\textcircled{1} and \textcircled{2}). The reward accumulated in the temporary account may be transferred to the user's member account later.

The identification value may be generated by the reward module 30 at the time of installation of the app or at the time of execution of the app (e.g., at the time of first execution), and the method of generating the identification value may be any method. For example, the reward module 30 may generate the identification value on the basis of a hash value of at least one piece of information among a timestamp value at the time of installation of the app (or at the time of execution of the app), information (e.g., a name of the app, an identifier of the app, etc.) related to the app, and information (e.g., a name of the terminal, an identifier of the terminal, etc.) related to the user terminal 20. However, the technical scope of the present disclosure is not limited thereto.

Further, the reward module 30 may regenerate (change) the identification value whenever reinstallation or initialization (e.g., deletion of data within the app) of the app is performed. Accordingly, the reward accumulated in the temporary account disappears every time the app is reinstalled or the app is initialized, thereby encouraging the user to rapidly sign up for membership and continue to use the app.

Further, the reward server 10 may force the user to sign up for membership at the time of using the reward by providing a store service in which only members can use the reward. As described above, the reward accumulated in the temporary account according to the membership registration may be transferred to the member account. As described above, it is possible to significantly lower a barrier to entry to the reward service by not forcing membership registration at the time of accumulating the reward, and it is possible to continuously increase the number of members using the accumulated rewards as collateral by forcing membership registration at the time of using the reward.

Meanwhile, according to some other embodiments of the present disclosure, the user may watch additional advertisement content and receive an additional reward in return for watching. More specifically, the reward module 30 may display a list of advertisement content received from the reward server 10 on the display of the user terminal 20 in response to a predetermined user input. Further, the reward module 30 may display advertisement content selected by the user from the list on the display, calculate the reward as described above, and transmit a request for accumulation of the calculated reward to the reward server 10. A method of generating the list of the advertisement content will be described with reference to the above-described content of the advertisement management unit 13. According to the present embodiment, the additional reward is provided to the user, and thus the user's profitability can be improved.

The method of providing the reward service according to some embodiments of the present disclosure has been described above with reference to FIGS. 4 to 12. According to the above-described method, the reward service may also be provided to the user of the non-reward app by using the insertion-type reward module 30. Accordingly, the reward advertising market may be significantly activated.

Hereinafter, an example in which cryptocurrency is used as a reward will be described with reference to FIGS. 13 and 14.

As illustrated in FIG. 13, in the present embodiment, a reward server 10 may communicate with a blockchain network 60. The blockchain network 60 is a network of a peer-to-peer (P2P) structure, which is formed by a plurality of blockchain nodes (e.g., 61 and 63), and the plurality of blockchain nodes (e.g., 61 and 63) may share blockchains (e.g., 71 and 73), which are distributed ledgers, through the blockchain network 60. Here, the sharing of the blockchains (e.g., 71 and 73) may mean that each of the plurality of blockchain nodes (e.g., 61 and 63) maintains one of the blockchains (e.g., 71 and 73) in which the same data is stored through a consensus process. In the blockchains (e.g., 71 and 73), transaction data 75 and smart contracts 77 which are used for transaction processing may be stored. Since the blockchains should be clearly understood by those skilled in the art, further description of a blockchain itself will be omitted in order not to obscure the gist of the present disclosure.

In the present embodiment, the reward may be calculated and paid based on cryptocurrency issued through the blockchain network 60. For example, by executing a smart contract that remits cryptocurrency to the user's account, the reward may be paid to the user. Further, a reward payment history may be recorded in the blockchains (e.g., 71 and 73) shared through the blockchain network 60. By doing this, the transparency and reliability of reward payment may be secured. A usage history of the reward used through a store service provided by the reward server 10 may also be recorded in the blockchains (e.g., 71 and 73).

Meanwhile, in various embodiments of the present disclosure, the blockchain network 60 may be a network that provides a multi-channel function. Here, the channel may be a small-scale blockchain network implemented on a blockchain network. In the case of a multi-channel blockchain network, channels may operate to share the blockchain. For example, as illustrated in FIG. 14, blockchain nodes belonging to a first channel 81 may operate to share a blockchain 83, and blockchain nodes belonging to a second channel 91 may operate to share a blockchain 93. The multi-channel function may be utilized in various ways, and embodiments related thereto will be briefly described below.

In some embodiments, transaction data (e.g., a reward payment history, a reward usage history, etc.) associated with a free app may be recorded in a blockchain shared through a first channel, and transaction data associated with a paid app may be recorded in a blockchain shared through a second channel. That is, a reward transaction associated with the free app may be handled through the first channel, and a reward transaction associated with the paid app may be handled through the second channel. For example, as illustrated in FIG. 14, transaction data (e.g., D1 and D2) associated with a first app 85, which is a free app, may be recorded in the blockchain 83 shared through the first channel 81, and transaction data (e.g., D3 and D4) associated with a second app 95, which is a paid app, may be recorded in the blockchain 93 shared through the second channel 91. In this case, a differential transaction processing service may be provided by applying a different consensus algorithm or security policy (e.g., whether additional encryption is performed) between the channels 81 and 91. For example, by applying a relatively weak consensus algorithm or security policy to the first channel 81 and applying a relatively strong consensus algorithm or security policy to the second channel 91, the transactions related to the paid app (or transaction data) may be handled more securely. Alternatively, by configuring the second channel 81 as a blockchain node with relatively high computing power or applying a relatively fast (light) consensus algorithm to the second channel 81, the transactions related to the paid app may be handled faster.

In some embodiments, a first transaction having a data size which is greater than or equal to a reference value may be handled through the first channel, and a second transaction having a data size which is smaller than the reference value may be handled through the second channel. In this case, by configuring the first channel as a blockchain node with relatively high computing power or applying a relatively fast (light) consensus algorithm to the first channel, the overall transaction processing speed can be improved. Alternatively, only metadata (e.g., a DB storage location of actual data and the like) for the data of the first transaction is recorded in the blockchain shared through the first channel, and the actual data is recorded in a DB, and thus the transaction processing speed can be improved.

The example in which the cryptocurrency is used as the reward has been described above with reference to FIGS. 13 and 14. Hereinafter, an exemplary computing device 100 that can be used to implement the devices (e.g., the reward server 10 or the user terminal 20) according to various embodiments of the present disclosure will be described with reference to FIG. 15.

FIG. 15 is an exemplary hardware configuration diagram illustrating a computing device 100.

As illustrated in FIG. 15, the computing device 100 may include one or more processors 110, a bus 150, a communication interface 170, a memory 130 for loading a computer program executed by the processor 110, and a storage 190 for storing a computer program 191. However, only components related to the embodiment of the present disclosure are illustrated in FIG. 15. Therefore, it can be seen by those skilled in the art to which the present disclosure pertains that the present disclosure may further include general-purpose components in addition to the components illustrated in FIG. 15. That is, the computing device 100 may further include various components in addition to the components illustrated in FIG. 15. For example, the computing device 100 may further include input devices (not illustrated) such as a keyboard, a mouse, a microphone, a camera, and the like, output devices (not illustrated) such as a display, a speaker, and the like, or various types of sensor devices. Here, the display may be a device having a built-in input function, such as a touch screen. Hereinafter, each component of the computing device 100 will be described.

The processor 110 controls the overall operation of each component of the computing device 100. The processor 110 may include at least one of a central processing unit (CPU), a microprocessor unit (MPU), a micro controller unit (MCU), a graphics processing unit (GPU), or any type of processor well known in the art of the present disclosure. Further, the processor 110 may perform an operation for at least one application or program for executing the operations/methods according to the embodiments of the present disclosure. The computing device 100 may include one or more processors.

The memory 130 is configured to store various pieces of data, commands, and/or information. One or more programs 191 may be load into the memory 130 from the storage 190 to execute the operations/methods according to the embodiments of the present disclosure. For example, when the computer program 191 in which the function of the reward module 30 is implemented is loaded into the memory 130, a module may be implemented on the memory 130, as illustrated in FIG. 3. The memory 130 may be implemented as a volatile memory such as a random access memory (RAM), but the technical scope of the present disclosure is not limited thereto.

The bus 150 provides a communication function between the components of the computing device 100. The bus 150 may be implemented as one of various types of buses such as an address bus, a data bus, a control bus, and the like.

The communication interface 170 supports wired/wireless Internet communication of the computing device 100. Further, the communication interface 170 may support various communication methods other than the Internet communication. To this end, the communication interface 170 may include any type of communication module well known in the art of the present disclosure.

The storage 190 may be configured to non-temporarily store the one or more programs 191. The storage 190 may include a non-volatile memory such as a read-only memory (ROM), an erasable programmable ROM (EPROM), an electrically erasable programmable ROM (EEPROM), a flash memory, or the like, a hard disk, a removable disk, or any type of computer-readable recording medium well known in the art to which the present disclosure pertains.

The computer programs 191 may include one or more instructions that, when loaded into the memory 130, cause the processor 110 to perform the operations/methods according to various embodiments of the present disclosure. That is, the processor 110 may perform the operations/methods according to various embodiments of the present disclosure by executing the one or more instructions.

As an example, the computer programs 191 may include one or more instructions constituting an app into which the reward module 30 is inserted, and the computing device 100 may further include a display (not illustrated). Further, the reward module 30 may include one or more instructions for performing an operation of transmitting calculated rewards to the reward server 10 through the communication interface 170 on the basis of an operation of displaying an indicator displaying an earnable reward while the app is running on the display (not illustrated), an operation of detecting the user input received through the output indicator, an operation of displaying advertisement content on the display (not illustrated) in response to the detected user input, and the earnable reward. In addition, the reward module 30 may further include one or more instructions for performing operations/methods related to various embodiments of the present disclosure described above. In this case, the user terminal 20 according to some embodiments of the present disclosure may be implemented using the computing device 100.

As another example, the computer program 191 may include one or more instructions for performing an operation of transmitting advertisement content in response to a request from the user terminal 20 and an operation of accumulating a reward corresponding to the user in response to a request for accumulation of the reward from the user terminal 20. In addition, the computer program 191 may further include one or more instructions for performing operations/methods related to various embodiments of the present disclosure described above. In this case, the reward server 10 according to some embodiments of the present disclosure may be implemented using the computing device 100.

The exemplary computing device 100 that can be used to implement the devices (e.g., the reward server 10 and the user terminal 20) according to various embodiments of the present disclosure has been described above with reference to FIG. 15.

The technical idea of the present disclosure that has been described with reference to FIGS. 1 to 15 may be implemented as computer-readable code in a computer-readable medium. The computer-readable recording medium may include, for example, a removable recording medium (e.g., a compact disc (CD), a digital video disc (DVD), a Blu-ray disc, a Universal Serial Bus (USB) storage device, or a removable hard disk) or a fixed recording medium (e.g., a ROM, a RAM, or a computer-equipped hard disk). The computer program recorded on the computer-readable recording medium may be transmitted to another computing device through a network such as the Internet and installed in the another computing device, thereby being used in the another computing device

While the above-described embodiments of the present disclosure describe that all components are combined into one unit or are operated in a combined manner, the present disclosure is not limited thereto. That is, within the scope of the present disclosure, one or more of the components may be selectively combined and operated.

While the accompanying drawings illustrate operations in a particular order, this does not mean that these operations should be performed in the specific order or sequence illustrated or that all illustrated operations should be performed in order to obtain a desired result. In a particular case, multi-tasking and parallel processing may be advantageous. Moreover, separation of various system components in the above embodiment does not mean that such separation is required for all embodiments. In general, described program components and systems may be integrated in a single software product or may be packed in multiple software products.

The embodiments of the present disclosure have been described above with reference to the accompanying drawings. It should be understood by those skilled in the art that the present disclosure may be embodied in forms different from the disclosed embodiments without departing from the scope of the present disclosure and without changing essential features thereof. Therefore, the embodiments described above should be considered as only examples in all aspects and not for purposes of limitation. Accordingly, the scope of the present disclosure should be defined only by the following claims. The scope of the present disclosure is defined by the appended claims and encompasses all modifications and equivalents that fall within the scope of the appended claims.

What is claimed is:

1. A system for providing a reward service using an insertion-type reward module, the system comprising:
a reward module which is inserted into an app, displays a predetermined indicator while the app is running, displays advertisement content in response to an input of a user associated with the displayed indicator, and transmits a request for accumulation of rewards calculated according to predetermined conditions to a reward service providing server; and
the reward service providing server configured to accumulate the calculated rewards corresponding to the user in response to the request for accumulation.

2. The system of claim 1, wherein the reward module probabilistically determines whether to display the advertisement content in response to the input of the user.

3. The system of claim 1, wherein the reward module probabilistically determines whether to display the predetermined indicator.

4. The system of claim 1, wherein the reward module calculates an earnable reward and displays the calculated earnable reward together inside of the indicator or adjacent to the indicator.

5. The system of claim 4, wherein the earnable reward is calculated in an increasing manner over time.

6. The system of claim 1, wherein the reward module calculates an earnable reward and determines a visual element of the indicator on the basis of the calculated earnable reward.

7. The system of claim 6, wherein the visual element includes transparency.

8. The system of claim 1, wherein the reward module displays the indicator on an execution screen of the app in a floating manner.

9. The system of claim 1, wherein the reward module calculates an earnable reward and provides the calculated earnable reward in the form of a push notification in response to determining that the app is running in the background.

10. The system of claim 1, wherein:
the reward module generates an identification value associated with the app; and
the reward service providing server is configured to accumulate the calculated rewards corresponding to the generated identification value before an account of the user is generated, and
transfer the accumulated rewards to the account of the user in response to the generation of the account of the user.

11. The system of claim 10, wherein the identification value is regenerated when the app is reinstalled or initialized.

12. The system of claim 1, wherein:
the rewards are calculated based on cryptocurrency; and
the reward service providing server is configured to pay the calculated rewards in conjunction with a blockchain network and record a payment history for the calculated rewards in a blockchain shared in the blockchain network.

13. The system of claim 12, wherein:
the app includes a free app and a paid app;
the blockchain network is a multi-channel-based blockchain network including a first channel and a second channel; and
the reward service providing server is configured to record a payment history for rewards associated with the free app in a first blockchain shared through the first channel and record a payment history for rewards associated with the paid app in a second blockchain shared through the second channel,
wherein a first consensus algorithm is applied to the first channel, and a second consensus algorithm stronger than the first consensus algorithm is applied to the second channel.

14. A method of providing a reward service using an insertion-type reward module, which is a method of providing a reward service using a reward module inserted into an app in a terminal of a user, the method comprising:
outputting an indicator displaying an earnable reward while the app is running through a display of the terminal;
detecting an input of the user associated with the displayed indicator;
displaying advertisement content through the display in response to the detected input of the user; and
accumulating rewards calculated based on the earnable reward corresponding to the user.

15. A user terminal comprising:
a display;
a memory configured to store an app into which a reward module is inserted;
a communication unit configured to communicate with a reward service providing server; and
a processor configured to control the display, the memory, and the communication unit,
wherein the processor is set to output an indicator displaying an earnable reward while the app is running through the display,
detect an input of the user associated with the output indicator,
display advertisement content through the display in response to the detected input of the user, and
transmit the calculated rewards to the reward service providing server through the communication unit so that the calculated rewards are accumulated based on the earnable reward to correspond to the user.
